(19) United States
(12) Patent Application Publication
(10) Pub. No.: US 2012/0086581 A1
(43) Pub. Date: Apr. 12, 2012

(54) WATER MONITORING SYSTEM

(75) Inventors: David A. Marsell, Yorktown, VA (US); Steven M. Keeter, Newport News, VA (US); Randall S. Akers, Virginia Beach, VA (US)

(73) Assignee: Measurement Specialties Inc., Hampton, VA (US)

(21) Appl. No.: 13/252,726

(22) Filed: Oct. 4, 2011

Related U.S. Application Data
(60) Provisional application No. 61/389,364, filed on Oct. 4, 2010.

(51) Int. Cl. G08C 15/06

(52) U.S. Cl. 340/870.02

(57) ABSTRACT

A water monitoring system includes a plurality of remotely-located nodes for measuring water characteristics, and transmitting measured data to a central gateway device over at least one local RF connection. The gateway is operative to transmit cumulative data received from the plurality of nodes over a single cellular or satellite connection to a central processing system.

### CROSS REFERENCE TO RELATED APPLICATIONS

This application claims the benefit of U.S. Provisional Patent Application Ser. No. 61/389,364, filed Oct. 4, 2010, the entire disclosure of which is incorporated by reference herein.

### FIELD OF THE INVENTION

The present invention relates to water management systems, more specifically, to systems and methods for measuring and reporting characteristics of water supplies, including groundwater and surface water supplies.

### BACKGROUND

Proper water management is critical to ensuring a sufficient and continuous supply of water resources to individuals, industry and agriculture. Management systems collect and analyze data indicative of, for example, water level and water quality. This data may be used to monitor consumption rates, control the collection and distribution of resources, as well as identify and isolate contaminated sources. These management systems improve overall efficiency and aid in resource conservation.

Current water monitoring systems provide water level or quality information through a variety of techniques that may include, but are not limited to, visual measurements of water level using distance measuring devices (e.g. tape measures), measurements from mechanical gauges, or measurements from electronic sensors or transducers. These systems may collect data from one or more locations within a given area of study. In the case of groundwater monitoring, monitoring wells are often used to gain access to the water.

Relevant data may be recorded through various means, including manual data collection, hardcopy log recordings, as well as through electronic storage devices, such as data logging equipment capable of storing outputs from digital or analog electronic sensors (e.g. transducers). This data may be acquired through on-site readings to monitoring wells or water reservoirs, or through various forms of telemetry using long-range radio frequency (RF) based communication devices, such as cellular/satellite radios, for transferring data from distributed locations to a central data collection computer.

These systems are limited, however, in that the sensors and/or sensor data loggers are physically hardwired to associated long-range data connections. Such an arrangement limits the number of sensors or data loggers that can make use of a single cellular or satellite licensed connection. Thus, these systems require a relatively large number of connections (e.g. one or more long-range radios for each sensor arrangement) for a sample area with a large geographical separation between sensors. This results in increased equipment purchase costs, as well as increased operational costs due to the large number of cellular or satellite data service contracts.

Alternative systems and methods are desired.

### SUMMARY

In one embodiment, a water monitoring system comprises at least one sensor configured to measure a characteristic of a body of water. The system further comprises a node having a wireless communication device responsive to the output of the at least one sensor for communicating data indicative of the sensor output. A gateway is provided having a wireless communication device configured to communicate with the wireless communication device of the node, and a second, long-range wireless communication device is configured to communicate with a remotely-located computer system. The gateway is configured to receive data indicative of the sensor output from the node, and transmit the data to the remotely-located computer system.

In another embodiment, a method for monitoring a body of water is provided. The method includes collecting from a plurality of nodes data indicative of at least one water characteristic. Each node includes at least one sensor. The collected data is transmitted from the plurality of nodes over at least one local wireless communications connection to a gateway device. The gateway device is operative to transmit received data from each of the plurality of nodes to a central processing system via a long-range cellular or satellite communications connection.

### BRIEF DESCRIPTION OF THE DRAWINGS

FIG. 1 is a partial schematic representation of a water monitoring system using a single long-range communication link for transmitting data to a remote location.

FIG. 2A is a partial schematic representation of a water monitoring system according to an embodiment of the present invention.

FIG. 2B is a partial schematic representation of the water monitoring system node illustrated in FIG. 2A according to an embodiment of the present invention.

FIG. 3 is a partial schematic representation of a water monitoring system gateway according to an embodiment of the present invention.

FIG. 4 is a simplified diagram illustration an exemplary topology of a water monitoring system according to an embodiment of the present invention.

FIG. 5 is a block diagram illustrating the function of a water monitoring system according to an embodiment of the present invention.

### DETAILED DESCRIPTION

It is to be understood that the figures and descriptions of the present invention have been simplified to illustrate elements that are relevant for a clear understanding of the present invention, while eliminating, for purposes of clarity, many other elements found in typical water monitoring systems. However, because such elements are well known in the art, and because they do not facilitate a better understanding of the present invention, a discussion of such elements is not provided herein. The disclosure herein is directed to all such variations and modifications known to those skilled in the art.

In the following detailed description, reference is made to the accompanying drawings that show, by way of illustration, specific embodiments in which the invention may be practiced. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout several views.

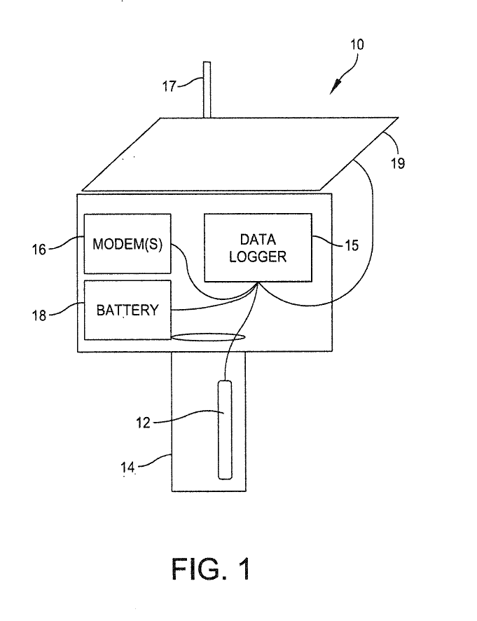

Referring generally to FIG. 1, an exemplary wireless water monitoring unit 10 is shown. Monitoring unit 10 includes one or more sensors 12. Sensor 12 is inserted into an underground well borehole 14 for measuring any number of water characteristics, such as, by way of non-limiting example, water level, temperature, pH, conductivity, turbidity, and/or water composition including salinity, Total Dissolved Solids (TDS), oxygen, nitrate and chloride levels. Data measured by sensor 12 is recorded by a data logger 15, and subsequently transferred to a remote receiving device, typically a computer in a control and/or data-processing center (not shown). This long-range data transfer may be accomplished via a cellular or satellite communications system, including, for example, a modem 16 and antenna 17. Power for the system may be provided by an internal battery 18, and/or a solar-cell arrangement 19. As set forth above, a given monitoring area may include numerous monitoring units 10 spread out over a substantial sampling area, each comprising an individual long-range data connection.

Embodiments of the present invention may remedy this shortcoming by providing a cost-effective and efficient system and method to remotely monitor water characteristics from a plurality of water monitoring locations. Embodiments may utilize relatively inexpensive short-range data connections (e.g. RF telemetry) to allow one or more data collection devices, or “nodes”, to aggregate measured data to a central device, or “gateway”. The gateway may utilize a single, shared cellular or satellite data connection for long-range data telemetry, eliminating the need for the multiple long-range connections and their accompanying subscriptions.

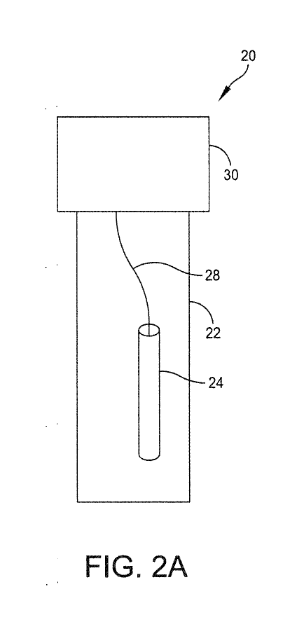

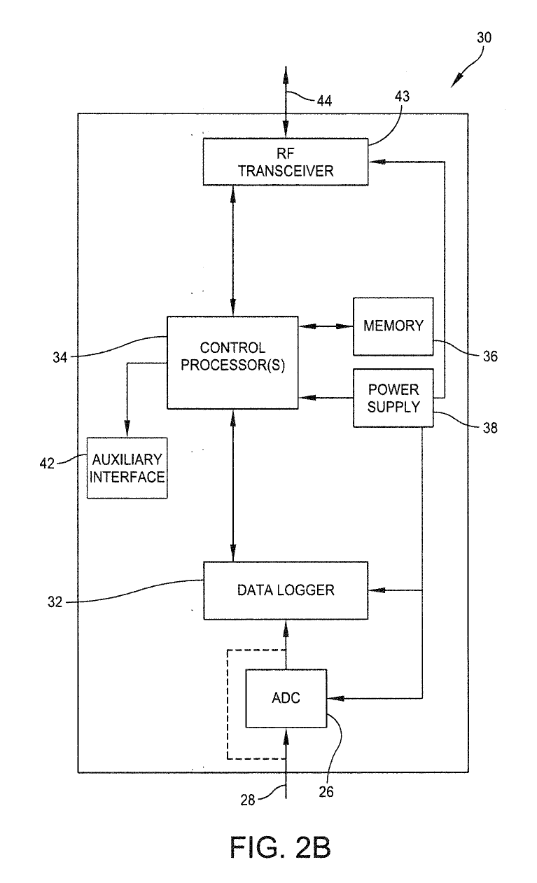

Referring generally to FIGS. 2A and 2B, embodiments of the present invention include a system for remotely monitoring one or more data collection points with a corresponding number of monitoring units 20. As set forth above with respect to FIG. 1, each monitoring unit 20 may be located, for example, at a respective groundwater monitoring well. One or more water level, or water quality sensors 24 (e.g. transducers) may be arranged within a given well borehole 22. Each sensor 24 may provide an analog or digital output indicative of a measured parameter, such as, by way of non-limiting example, water level. Each unit 20 may further comprise a local processing and transmitting device, or node 30, responsive to the output of sensor(s) 24.

With reference to FIG. 2B, each node 30 receives an output 28 of sensor 24 for storing and/or transmitting measured data. In one embodiment, output 28 of each sensor 24 may be provided to a data logger 32. Data logger 32 may include, for example, a processor, memory and/or a power supply (not shown) for recording the output of each sensor 24. In the case of an analog sensor output, additional processing components, such as an A/D converter 26 may be provided to generate a digital representation of the measurement data received from sensor 24.

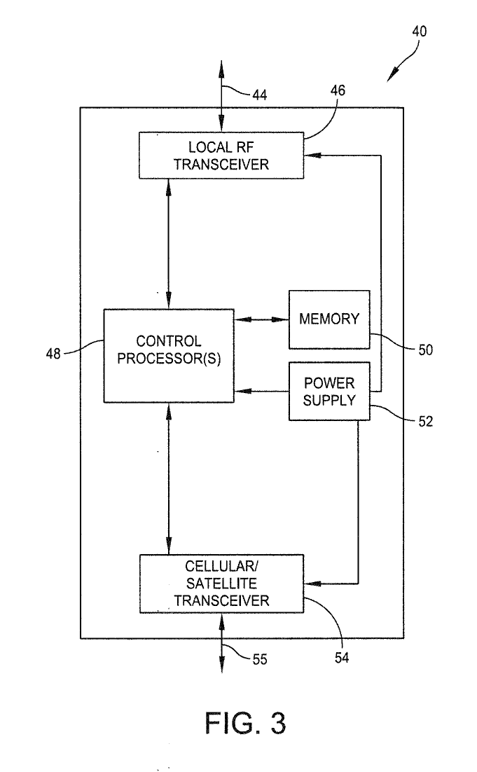

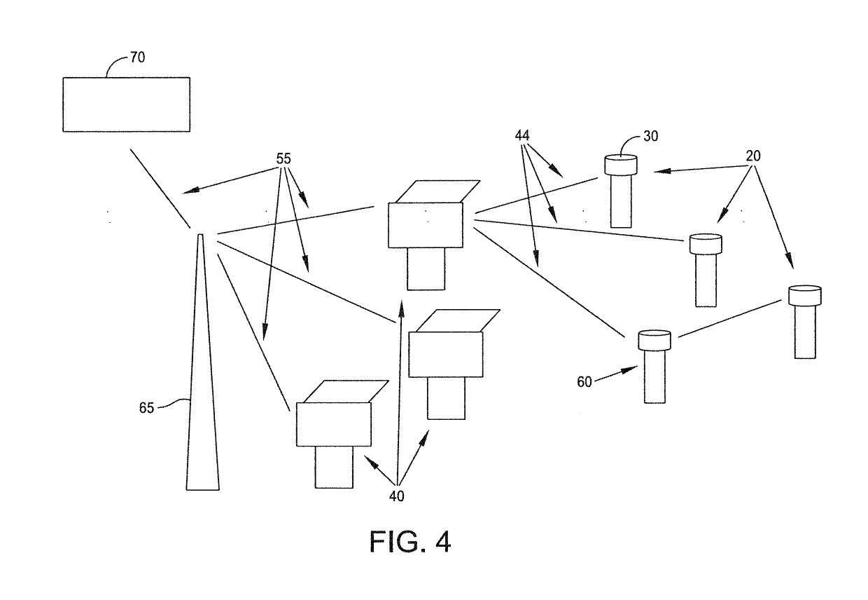

Node 30 is configured to transfer stored water characteristic data to a gateway 40 (FIGS. 3 and 4), via, for example, a local wireless data connection 44. In one embodiment, the wireless connection utilizes unlicensed RF communication devices (e.g. modems operating on a WLAN based on IEEE 802.11 standards) to communicate between each node 30 and gateway 40 of a system. Node 30 may further include one or more control processors 34 for performing any number of device functions including, but not limited to, selectively controlling the operation of data logger 32 and/or sensor 24, retrieving data stored on data logger 32, writing/reading received data to/from a memory device 36, and selectively transmitting and/or receiving data over local wireless data connection 44 (e.g. an RF link or network) via a transceiver 43. Transmitted data may include water characteristic data, data identifying the node, node status data, such as power status, sensor status data, and error condition alert data, by way of non-limiting example. In one embodiment, data logger 32 may be omitted, and at least one control processor 34 may be responsive to a set of instructions for recording the output of each sensor 24 to memory device 36. Control processors 34 may also be responsive to command/control data (e.g. instructions) received via an interface 42 (e.g. communication port), or wirelessly through transceiver 43. Node 30 may comprise an onboard power supply 38, such as one or more batteries for powering the various components thereof, including sensor(s) 24. Power may also be supplied to any or all of these components via an external source.

FIG. 3 shows an exemplary gateway device 40 according to an embodiment of the present invention. As set forth above, gateway 40 is operative to communicate with one or more nodes 30 via a local communications link, such as a local, unlicensed RF data connection. In the exemplary illustrated embodiment, gateway 40 comprises, for example, a transceiver 46 for communicating with a plurality nodes 30 via data connection 44. Gateway 40 may selectively or continuously receive stored water characteristic data from any or all nodes 30 of a given monitoring system. Data received by gateway 40 may be stored, and/or selectively or continuously transmitted to a remote monitoring system via transceiver 54 over a long-range data connection, such as a cellular or satellite connection 55. One or more control processors 48 are provided for controlling, by way of example only, data transmission and reception over the local RF connection, the writing/reading of data to/from a memory device 50, and control of the cellular or satellite radio system, including transceiver 54.

FIG. 4 is a simplified system diagram of a water monitoring system according to an embodiment of the present invention incorporating the above-described node/gateway arrangement. As set forth above, a plurality of monitoring units 20 are provided for collecting, storing and transmitting water data. Each monitoring unit 20 comprises a node 30 for storing and selectively transmitting this data over, for example, a local wireless data connection to one or more gateways 40. Embodiments of the present invention may also include one or more repeaters 60 configured to receive, amplify and re-transmit the RF data signal over connection 44 for extending the operational range of communications between nodes 30 and gateways 40.

In the illustrated embodiment, each gateway 40 is responsive to more than one node 30 for receiving and storing the measured data. Once received, a long-range cellular or satellite link 55 is provided (e.g. through a cellular network 65) for transmitting cumulative data received from a plurality of nodes 30 to at least one remote processing location, including, for example, a computer system 70.

System 70 may be configured to receive and process data for user interpretation. This may be achieved through software running on system 70, or through an accessible web-based application. System 70 may make stored data available for display and transfer through either a user interface or machine-to-machine (M2M) protocol. System 70 may allow for control of the monitoring system, including control of gateways 40 and nodes 30. More specifically, the data transfer interval from the nodes to the gateway(s), and the gateway(s) to system 70, may be user-defined to meet reporting and power conservation and management needs. System 70 may also provide individualized control of the sampling rate of sensors 24. Nodes 30 may be capable of receiving configuration and setup information either from system 70 via gateway(s) 40, or through a local wireless Ethernet interface or wired local interface. The local wireless Ethernet interface may display configuration and setup web pages for use with a device containing a web browser application. Likewise, gateways 40 are capable of receiving configuration and setup information from system 70, or through a local wired or wireless Ethernet interface. System 70 will also be capable of managing over-the-air updates of embedded software within any of the system components.

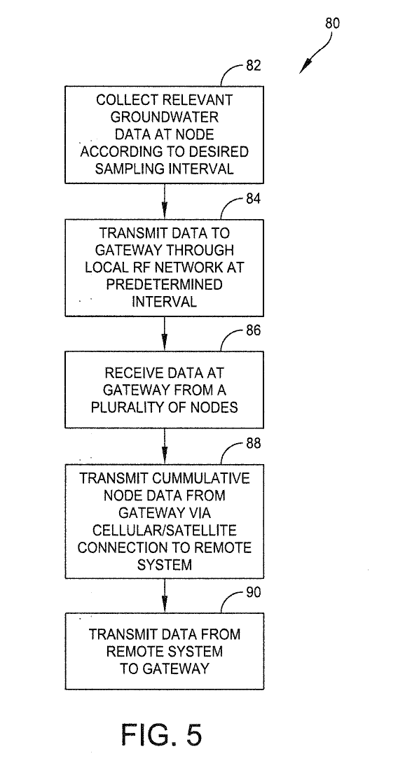

Referring generally to FIG. 5, an exemplary method of operation 80 of a system according to an embodiment of the present invention will be shown and described. In step 82, water characteristics may be measured by, for example, sensors arranged in one or more well boreholes. A local data storage/communication system (i.e. a node) may be operative to store this data continuously, at predetermined intervals, or in response to a received command instruction. Once collected, and referring generally to step 84, the data may be transmitted over a local RF link or network to a second device, such as the above-described centralized gateway. Data may be transmitted between the nodes and the gateway in real time, at predetermined intervals, or by a command instruction.

In step 86, one or more gateways are configured to receive data from one or more nodes. In an exemplary embodiment, a single gateway is implemented, and responsive to a plurality of individual nodes for receiving and storing data. Referring to step 88, the gateway is operative to transmit the data received from one of more nodes via a long-range communications link to one or more remote systems, such as the remote computer system/user interface 70, as set forth above. Exemplary connections may include, but are not limited to licensed RF-based cellular and satellite communication links.

Transmitted data may be analyzed by, for example, additional processing software, and/or displayed to a user for study. The remote computer system and user interface may also provide an input means for control commands. For example, setting sampling intervals, controlling the transfer of data and other system functions may be input by an operator, and a corresponding instruction transmitted (step 90) via the long-range cellular or satellite connection to the gateway, which may process and/or execute instructions, and/or relay instructions or data to one or more of the nodes via the local RF connection.

Gateways 40, nodes 30, and the remote computer system 70 are described and illustrated herein only as exemplary systems for performing the described water monitoring processes, and other embodiments may be contemplated by one of skill in the pertinent art without departing from the intended scope of this disclosure. For example, the process or processes explained herein may be performed by a processor, which processor accesses a memory device, the memory device containing instructions, which instructions, when executed by the processor, cause the steps of a method for communicating measured data between nodes, gateways, and remote computer systems to be performed by the processor. It is understood that the processes may also be performed by special-purpose hardware. Thus, the entire process or any part thereof, may be performed in hardware, software or any combination of hardware and/or software. Software may be embodied in a non-transitory machine readable medium upon which software instructions may be stored, the stored instructions when executed by a processor cause the processor to perform the steps of the methods described herein. Any suitable machine readable medium may be used, including but not limited to, magnetic or optical disks, for example CD-ROM, DVD-ROM, floppy disks and the like. Other media also fall within the intended scope of this disclosure, for example, dynamic random access memory (DRAM), random access memory (RAM), read-only memory (ROM) or flash memory may also be used.

While embodiments of the water monitoring system have been shown and described in the context of monitoring groundwater sources, it should be understood that embodiments of the system may be used to monitor all water sources, including surface water sources (e.g. lakes, streams, rivers, reservoirs, etc.) without departing from the scope of the present invention. Moreover, while embodiments of the water monitoring system describe a local RF network for connecting one or more nodes to one or more gateways, it should be understood that wired connections may also be implemented for one or more of these connections, while still realizing the benefits of reducing the number of long-range cellular or satellite connections required to implement the remote monitoring, systems described herein.

While the foregoing invention has been described with reference to the above-described embodiment, various modifications and changes can be made without departing from the spirit of the invention. Accordingly, all such modifications and changes are considered to be within the scope of the appended claims. Accordingly, the specification and the drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed.

What is claimed is:

1. A water monitoring system comprising:
at least one sensor configured to measure a characteristic of a body of water;
a node comprising a first wireless communication device responsive to the output of the at least one sensor for communicating data indicative of the sensor output;
a gateway comprising:
a second wireless communication device configured to communicate with the first wireless communication device of the node, and
a third wireless communication device configured to communicate with a remotely-located computer system,
wherein the gateway is configured to receive data indicative of the sensor output from the node, and transmit the data to the remotely-located computer system.

2. The system of claim 1, wherein the third wireless communication device comprises a cellular or satellite communications device for transmitting data received from the node to the remotely-located computer system.

3. The system of claim 1, wherein the node comprises a plurality of nodes, and the gateway is responsive to data received from each of the nodes.

4. The system of claim 1, wherein the node further comprises a data logger, a control processor, and a memory storage device.

5. The system of claim 1, wherein the node is configured to receive instructions from the gateway via the first wireless communication device.

6. The system of claim 1, wherein the gateway further comprises a control processor and a memory device.

7. The system of claim 1, wherein the gateway is configured to receive control instructions from the remotely-located computer system via the third wireless communication device.

8. The system of claim 1, wherein the node and the gateway communicate via an unlicensed local radio frequency (RF) network.

9. The system of claim 1, wherein the remotely-located computer system is operative to selectively control the operation of the gateway and the node.

10. A method for monitoring a body of water, the method including:
collecting data indicative of at least one water characteristic from a plurality of nodes, each node comprising at least one sensor;
transmitting the collected data from the plurality of nodes over at least one local wireless data connection to a gateway device; and
transmitting received data from each of the plurality of nodes from the gateway device to a central processing system via a cellular or satellite data connection.

11. The method of claim 10, further comprising the step of transmitting operating commands from the central processing system to the gateway device via the cellular or satellite communication system.

12. The method of claim 10, further comprising the step of transmitting operating commands from the gateway device to the plurality of nodes via the at least one local wireless data connection.
